(19) United States
(12) Patent Application Publication
(10) Pub. No.: US 2015/0332604 A1
(43) Pub. Date: Nov. 19, 2015

(54) POLICE TRAINING DEVICE

(71) Applicant: ALFRED C. RICH, CAPE CORAL, FL (US)

(72) Inventor: ALFRED C. RICH, CAPE CORAL, FL (US)

(21) Appl. No.: 14/710,667

(22) Filed: May 13, 2015

Related U.S. Application Data
(60) Provisional application No. 61/994,913, filed on May 18, 2014.

(51) Int. Cl. G09B 19/00; F41A 33/00; F41C 33/02

(52) U.S. Cl. CPC G09B 19/00; F41C 33/029; F41A 33/00

(57) ABSTRACT

A police training belt system comprising a belt strap, said belt strap having a length, opposite first and second ends, and complementary first and second coupling members provided adjacent the first and second ends of the belt, respectively; a plurality of attachment means for affixing police equipment replicas to said belt strap arrayed about the circumference of said belt strap; and safety device for a replica of a firearm comprising a holster adapted to receive a replica firearm affixed to said belt strap.

### FIELD OF THE INVENTION

The present invention relates generally to police training devices and more specifically to a simulated police duty belt.

### BACKGROUND

During training simulations, police officers generally must take off any equipment that may pose a danger in a training environment such as guns, tasers, sprays and the like. However, removing the equipment is often detrimental to the officers' training experience by reducing their overall preparedness and fitness for duty. As such, it would be useful to have a simulated duty belt that can be adjusted for weight, gear and individual officer preferences for positioning of duty gear that could be used during training situations that involve arrest and control, ground fighting or any other scenario based on police training

### BRIEF SUMMARY OF THE INVENTION

While the prior art describes weighted belts whose sole purpose is to serve as training device for the general public to simulate training at a higher body weight, the present invention is a device to be used primarily by law enforcement officers. The police training device of the present invention is comprised of a belt and a plurality of equipment replicas attachably fastened to the belt using a plurality of fastening devices. The belt, equipment replicas and fastening devices are constructed of soft weight so as to not injure officers or their training partners during training exercises. The police training device is adjustable so that officers can move equipment replicas to positions on the belt that would match the position they normally wear their duty equipment. The belt of the present invention simulates patrol duty belt with a Velcro line so that officers can attach it to an inner Velcro belt, as is done with a normal duty belt. The police training device may also comprise a gun holster with an alarm system that provides immediate feedback to officers and/or instructors when an equipment replica of a gun has been pulled from the gun holster during weapon retention training situations. The holster alarm is generally comprised of a pressure switch, front back and side surfaces, a battery cover, a hinge and a means for activating and deactivating the alarm.

In the preferred embodiment, the equipment replicas are constructed from a soft yet durable mold of the duty gear it replicates. Weights may be inserted inside the molds such that the equipment replica is about the same weight of the duty gear it replicates. Further, it is contemplated that flexible soft weights may be placed in pouches and moved to the areas of the police training device for different training simulations.

### BRIEF DESCRIPTION OF THE DRAWINGS

FIG. 1 is a perspective view of the outward facing side of the police training device of the present invention.

FIG. 2 is a perspective view of the inward facing side of the police training device of the present invention.

FIG. 3A is a perspective view of the equipment replica of the gun and holster alarm of the present invention.

FIG. 3B is a perspective view of the equipment replica of the gun and holster alarm of the present invention as shown in a cutaway view in the gun holster.

FIG. 4A is a back perspective view of the holster alarm of the present invention in the open position.

FIG. 4B is a front perspective view of the holster alarm of the present invention in the open position.

FIG. 4C is a side perspective view of the holster alarm of the present invention in the closed position.

### DETAILED DESCRIPTION

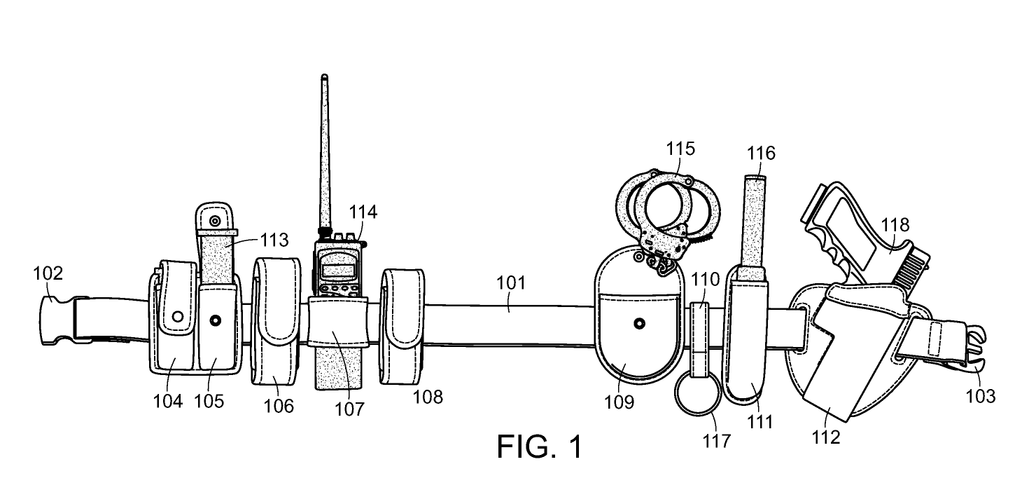

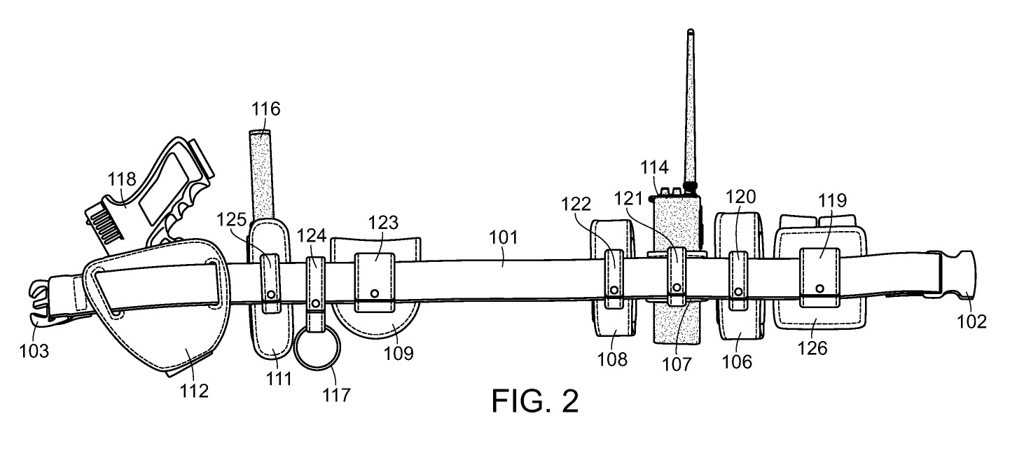

Turning to FIG. 1, the police training device of the present invention is shown, wherein the belt strap 101 is secured around the body, preferably at the waist, by inserting the belt clasp insert 103 into the belt clasp 102 such that the equipment replicas are facing outward from the body. A plurality of equipment replica, represented in FIGS. 1 and 2 as replicas of ammunition magazine 113, radio 114, handcuffs 115, expandable baton 116 and gun 118 are secured to the belt strap 101 using a plurality of fastening devices. For example, as shown in FIGS. 1 and 2, the ammunition magazine 113 rests in pouches 104 and 105, which form a common fastening device using back side 126 and back clasp 119. In another example, radio 114 is fastened to the belt strap 101 using radio holster 107 coupled with back clasp 121. Further, handcuffs 115 is fastened to the belt strap 1010 using handcuff case 109 and back clasp 123. As shown in FIGS. 1 and 2, a flashlight may be fastened to the belt strap 101 using a flashlight ring strap 110 with a back clasp 124 wherein the flashlight is attachably connected to the flashlight ring 117. In another example, expandable baton 116 is fastened to the belt strap 101 using expandable baton case 111 and back clasp 125. Finally, the gun 118 is fastened to the belt strap 101 using gun holster 112 which has slots on each side of the gun holster 112 such that the holster slides along the belt strap 101 upon insertion of the belt strap 101 through the slots.

Additional weights may be placed in pouches and fastened along the belt strap 101. For example, as shown in FIGS. 1 and 2, additional weights are placed in pouches 106 and 108, which are fastened to the belt strap 101 using back clasps 120 and 122, respectively.

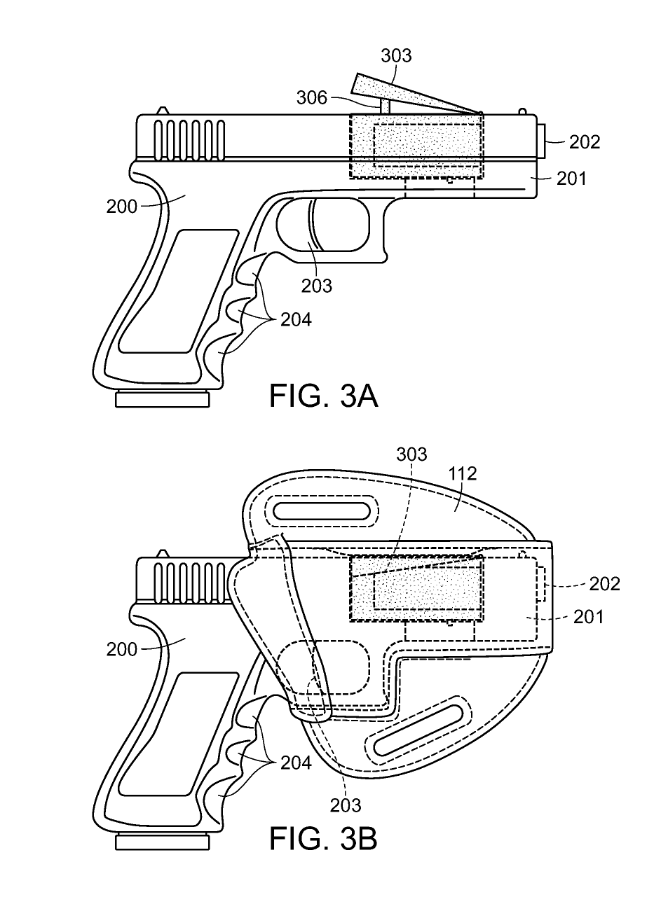

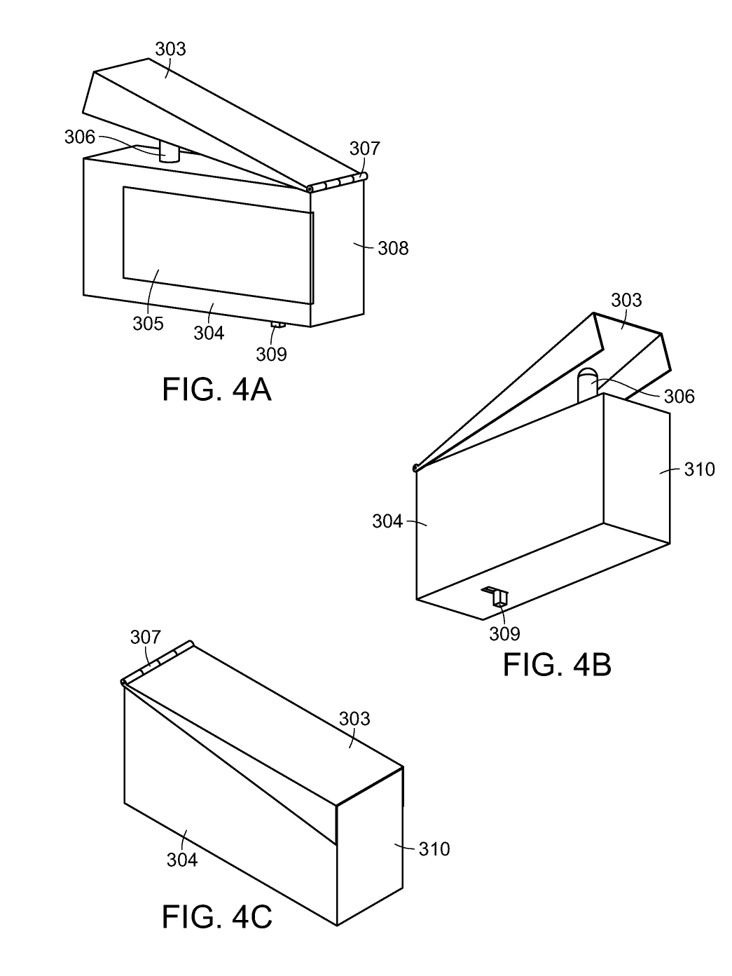

The user of the police training device may be alerted when the gun 118 is removed from the holster 112 by using a holster alarm, shown in further detail in FIGS. 3A-B and 4A-C. Turning to FIGS. 4A-C, the holster alarm generally is comprised of a pressure switch cover 303 which contacts the pressure switch 306. The pressure switch cover 303 is attachably connected to the back surface 308 using a hinge like device 307. The side cover 304 holds the battery cover 305 and the battery or other energy device is placed within the front, back and side covers 310, 308 and 304 respectively. The holster alarm may be activated or deactivated using, for example, an on/off switch 309.

As shown in FIGS. 3A-B, the gun 118 is placed into the gun holster 112 with the gun handle 200 extending towards the user and with the handle grips 204 exposed. The gun trigger 203, gun barrel 202 and gun fixed slide 201 all remain covered by the holster 112. When the gun is in the holster as shown in FIG. 3B, the holster alarm is positioned adjacent to the gun. The pressure switch cover 303 contacts the pressure switch 306 in the closed position when the gun is in the holster. If the gun is removed from the holster as shown in FIG. 3A, the pressure switch cover 303 releases the pressure switch 306, triggering the alarm mechanism to transmit a signal or sound to the user.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A police training belt comprising:
a. A belt strap, said belt strap having a length, opposite first and second ends, and complementary first and second coupling members provided adjacent the first and second ends of the belt, respectively; and
b. A plurality of attachment means for affixing police equipment replicas to said belt strap arrayed about the circumference of said belt strap.

2. The police training belt of claim 1 further comprising a plurality of pouches affixed to the belt strap arrayed about the circumference of the belt strap, each of the pouches containing a weight.

3. The police training belt of claim 1 wherein the attachment means comprises a pouch with a clasp.

4. The police training belt of claim 1 wherein the attachment means comprises a holster with a clasp.

5. The police training belt of claim 1 wherein the attachment means comprises ring strap with a clasp.

6. The police training belt of claim 1 wherein the attachment means comprises a holster with slots on opposing sides wherein the holster slides along the belt strap upon insertion of the belt strap through the slots.

7. The police training belt of claim 1 wherein the police equipment replicas are selected from the group comprising replicas of ammunition magazine, radio, handcuffs, baton, gun, flashlight or combinations thereof.

8. A safety device for a replica of a firearm comprising a holster adapted to receive a replica firearm, said holster further comprising a pressure switch cover and an alarm.

9. The safety device of claim 8 wherein said pressure switch is operable by the contact of a portion of a firearm on said pressure switch when the replica firearm engages said holster.

10. The safety device of claim 9 wherein said device further comprises a power source with the pressure switch being electrically connected to said power source.

11. The safety device of claim 10 wherein said holster has a muzzle end for receiving the muzzle of the replica firearm, said contact switch being located on the muzzle end.

12. The safety device of claim 10 wherein the alarm signal is activated using said power source when the muzzle end of the replica firearm is disengaged from the holster.

13. The safety device of claim 12 wherein the alarm signal generates an audible sound.

14. The safety device of claim 12 further comprising a switch that activates and deactivates the alarm.

15. A police training belt system comprising:
a. A belt strap, said belt strap having a length, opposite first and second ends, and complementary first and second coupling members provided adjacent the first and second ends of the belt, respectively; and
b. A plurality of attachment means for affixing police equipment replicas to said belt strap arrayed about the circumference of said belt strap; and
c. A safety device for a replica of a firearm comprising a holster adapted to receive a replica firearm affixed to said belt strap.

16. The system of claim 15 wherein the safety device further comprises a pressure switch cover and an alarm.

17. The safety device of claim 16 wherein said pressure switch is operable by the contact of a portion of a firearm on said pressure switch when the replica firearm engages said holster.

18. The safety device of claim 17 wherein said device further comprises a power source with the pressure switch being electrically connected to said power source.

19. The safety device of claim 18 wherein said holster has a muzzle end for receiving the muzzle of the replica firearm, said contact switch being located on the muzzle end.

20. The safety device of claim 19 wherein the alarm signal is activated using said power source when the muzzle end of the replica firearm is disengaged from the holster.
